(19) United States
(12) Patent Application Publication
(10) Pub. No.: US 2009/0308416 A1
(43) Pub. Date: Dec. 17, 2009

(54) ULTRASONIC CLEANER COMPONENTS

(75) Inventors: Zachary Utz, Uniontown, OH (US); John Florian, Uniontown, OH (US); Douglas Mansor, Tallmadge, OH (US); James Fitzsimmons, Ravenna, OH (US); Dean Dao, Akron, OH (US); Jonathan Frato, Canton, OH (US); David Calvert, Clinton, OH (US)

Correspondence Address: KATTEN MUCHIN ROSENMAN LLP, 575 MADISON AVENUE, NEW YORK, NY, 10022-2585, US

(73) Assignee: COLTENE WHALEDENT INC., Cuyahoga Falls, OH (US)

(21) Appl. No.: 12/482,648

(22) Filed: Jun. 11, 2009

Related U.S. Application Data
(60) Provisional application No. 61/060,605, filed on Jun. 11, 2008.

(51) Int. Cl. B08B 3/00; B65D 25/00

(52) U.S. Cl. 134/115 R; 220/260; 137/800

(57) ABSTRACT

An ultrasonic cleaner apparatus with an opening mechanism including a plurality of lugs preferably formed on a top surface of the apparatus, a lid enclosing the apparatus and resting on the lugs when the lid is in a closed position, and a rim formed exterior to the lugs, wherein the lid is secured in an open position between two or more of the plurality of lugs and the rim. A drain assembly coupled to the ultrasonic cleaner provides an advantageous configuration for dispensing cleaning and/or sterilizing fluid and the like from the apparatus.

### CROSS-REFERENCE TO RELATED APPLICATION

This application claims priority to provisional patent application no. 61/060,605, filed Jun. 11, 2008, which is assigned to the assignee of the present invention and hereby incorporated herein by reference in its entirety.

### TECHNICAL FIELD

The present invention relates to ultrasonic cleaners operative to clean dental or medical instruments and the like, including, but not limited to, dentures, optical lenses, eyeglasses, and to a method for operating such cleaners.

### BACKGROUND INFORMATION

Professionals in the dental, laboratory and medical fields use ultrasonic systems to clean instruments, apparatus, labware, crowns, dentures and other devices prior to sterilization. Ultrasonic cleaning greatly reduces the risk of cross-contamination and infection that can occur with other types of cleaning. Hence this procedure is critical in protecting instruments and is at the center of infection risk control.

Ultrasonic cleaners use high frequency sound waves propagating in aqueous solutions to create bubbles that loosen and remove impurities from items to be cleaned. A typical ultrasound cleaner is configured with a housing defining a bath filled with a cleaning solution that is agitated by high frequency sound waves sufficient to create and burst up bubbles that remove impurities from instruments. An example of such an ultrasonic cleaner is disclosed in U.S. Design Pat. No. 315,040 fully incorporated herein by reference. Other examples of ultrasonic cleaners are disclosed in U.S. Pat. No. 4,903,718 is also incorporated herein by reference.

A cleaning solution utilized in the ultrasound cleaner configured with a bath is typically reused and, thus, tends to lose its effectiveness long before the bath is refilled with a new volume of the solution. Consequently, it is important that an operator keep track of how long the solution has been used and replace it in a timely manner.

Typically, an ultrasonic cleaner is used repeatedly during the day. A cleaning cycle may last a few minutes or longer depending on the selected cycle time period. In certain situations, knowing how much time is left before the cycle is completed is important. However, the known devices may lack a visual indicating means that would provide such information.

With the global economy expanding, many of the known ultrasound devices can be purchased all over the world. At least some of the known devices utilize a user display providing an operator with easily seen step-by-step operational instructions. Yet, the known devices may have limited communication capabilities and display instructions in a language unfamiliar to the operator. Accordingly, the marketability of such devices may suffer from a lack of comprehension. Still other devices are specifically manufactured to meet the linguistic requirements of the regions or countries to which these devices are exported. This, in turn, incurs unnecessary expenses on both manufactures and consumers.

It is, therefore, desirable to provide an ultrasonic cleaner that has the capability of providing the operator with an indication of how long the solution has been used. Also, it is desirable to provide an ultrasonic cleaner that has the capability of displaying the time remaining to complete a current cleaning cycle. Furthermore, it is desirable to provide an ultrasonic cleaner that has the ability to have operational instructions displayed in several different languages. Finally, it is desirable to provide an ultrasonic cleaner that has a control panel allowing the operator to utilize the cleaner in a simple and comprehensive manner. These desires have been addressed by the disclosures of U.S. patent application Ser. No. 11/750,654 (“the '654 Application”), which is incorporated by reference herein in its entirety.

Despite the useful features of the '654 application, there still remain several aspects of the ultrasonic cleaner described therein that require addressing. One is the manner in which a lid covering the ultrasonic cleaner can be opened and kept out of the way of the user, without placing that lid on some other surface that might result in contaminating the lid and therewith the cleaner itself. Further, the use of hinges or other typical opening devices that would alleviate the need to put the lid down is overly limiting as it permits only a single direction of opening based on the orientation of the hinges.

A second feature that requires addressing is the actual location of the display unit. The '654 application describes in detail the benefits of the display, but there is one shortcoming of that display, namely its fixed location on the unit. As a result a user must configure their workstation to accommodate the single location of the display. But sometimes this is neither easy nor efficient, thus an alternative is desired.

Finally, there is a drain knob located on the outside of the ultrasound cleaner that is used to drain the device. However, in the assembly of the device, this knob is somewhat challenging to assemble requiring removing a portion of the cover and the screwing in of a screw to secure the knob to the valve which controls the flow of the cleaning solution. Accordingly, an easier solution is required to streamline assembly and minimize the number of steps required for assembly.

### SUMMARY

The present disclosure addresses these needs and seeks to provide, under an exemplary embodiment, an ultrasonic cleaner apparatus provided with a cover that is removable securable in four different locations on the unit without needing to be placed on a surface separate from the device.

Under another exemplary embodiment, an ultrasonic cleaner apparatus is disclosed having two or more different mounting locations such that a display can be moved to a convenient side of the device by the user enabling set-up that is most convenient for the user in their work space.

Under yet another exemplary embodiment, a drain knob is disclosed that can be coupled to a valve stem in a single step. The knob is preferably configured having openings formed thereon for receiving projections formed on a coupling. At least one of these projections include a ramped surface, where the projection with the ramped surface is flexible and deflects away from a surface of the knob when the knob is slid onto the coupling. The ramped surface also includes a flat that engages the opening securing the knob to the coupling.

An exemplary ultrasonic cleaner opening mechanism is also disclosed to include a plurality of lugs formed on an top surface of the ultrasonic cleaner, a lid enclosing the ultrasonic cleaner and resting on the lugs when the lid is in a closed position, and a rim formed exterior to the lugs, wherein the lid is secured in an open position between two or more of the plurality of lugs and the rim.

Under yet another exemplary embodiment, an ultrasonic cleaner is disclosed to include an enclosure for housing items to be cleaned during the cleaning cycle in a bath of the cleaning solution, a user interface for selecting functions and timing of actions to be taken by the ultrasonic cleaner, two or more locations for mounting the user interface to the ultrasonic cleaner, and a cover to prevent the ingress of foreign material (e.g., fluids and debris) into the other of the locations to which the user interface is not mounted.

Under yet another exemplary embodiment, a drain assembly is disclosed to include a drain valve, a coupling operably engaging the drain valve, the coupling including at least one alignment projection and at least one ramped projection, and a drain knob, said drain knob engaging the coupling and including at least one straight opening for receiving the alignment projection and at least one securing opening to receive the ramped projection and prevent the removal of the drain knob from the coupling once inserted therein.

Other objects, features, and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a front perspective view of an ultrasonic cleaner apparatus according to one exemplary embodiment;

FIGS. 2A-2D illustrate different views of a top portion of the ultrasonic cleaner of FIG. 1;

FIG. 3A is a top view of a lid for an ultrasonic cleaner according to another exemplary embodiment;

FIGS. 3B and 3D are different side views of the lid for an ultrasonic cleaner according to the exemplary embodiment of FIG. 3A;

FIG. 3C is a bottom view of the lid for an ultrasonic cleaner according to the exemplary embodiments of FIG. 3a and 3b;

FIG. 4 is a perspective view of a portion of the ultrasonic cleaner according to the exemplary embodiment of FIG. 1;

FIG. 5 is a perspective view of another portion of the ultrasonic cleaner according to the exemplary embodiment of FIG. 1;

FIG. 6 is a perspective view of yet another portion of the ultrasonic cleaner according to the exemplary embodiment of FIG. 1;

FIG. 7 is a perspective view of yet another portion of the ultrasonic cleaner according to the exemplary embodiment of FIG. 1;

FIG. 8 is a bottom view of an ultrasonic cleaner and drain valve according to another exemplary embodiment;

FIG. 9 is a blown-up view of a drain valve and knob assembly of an ultrasonic cleaner according to the exemplary embodiment of FIG. 8;

FIG. 10A is a top view of a drain knob according to the exemplary embodiment of FIG. 9;

FIG. 10B is a first side view of a drain knob according to the exemplary embodiment of FIG. 9;

FIG. 10C is a second side view of a drain knob according to the exemplary embodiment of FIG. 9;

FIGS. 11A-11D are different views of a coupling for a drain valve of an ultrasonic cleaner according to the exemplary embodiment of FIG. 9; and

FIGS. 12A and 12B illustrate different views of the ultrasonic cleaner, drain valve and knob assembly according to the exemplary embodiment of FIG. 8

### DETAILED DESCRIPTION

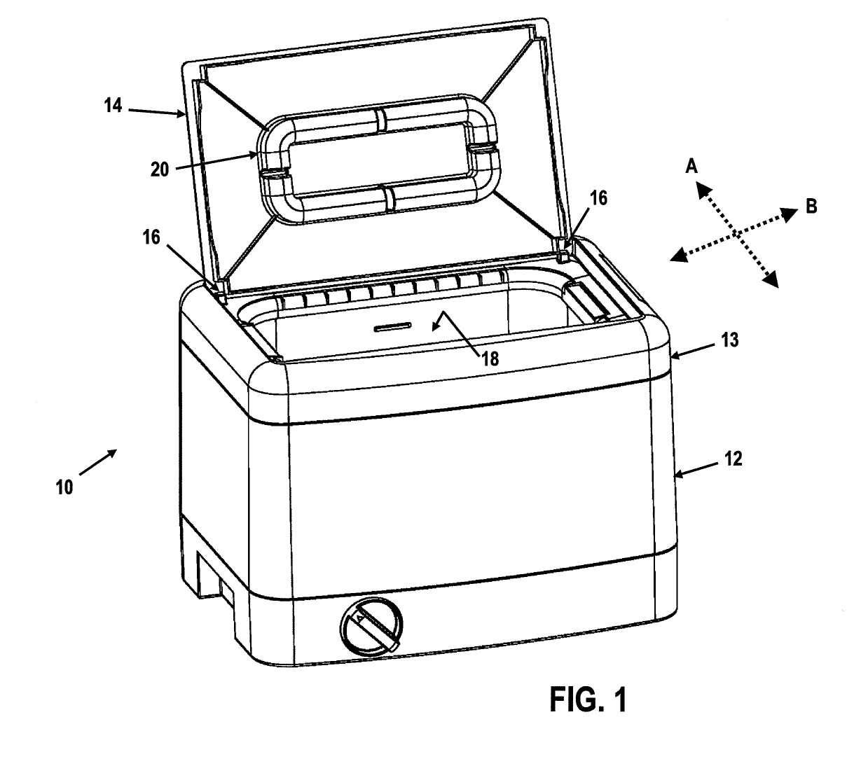

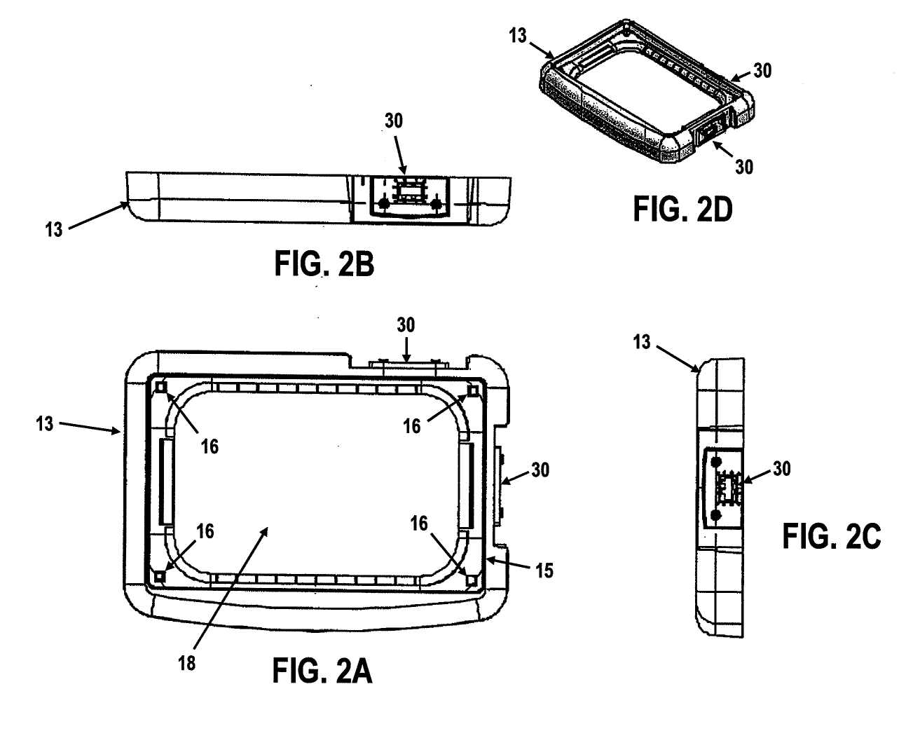

FIG. 1 shows a first aspect of a ultrasonic cleaner apparatus 10 according to an exemplary embodiment. The ultrasonic cleaner apparatus 10 includes a housing 12, a top portion 13 and a lid 14. The interior 18 of the ultrasonic cleaner is where a fluid would be placed and into which fluid objects for cleaning and/or sterilization would also be placed. The apparatus 10 includes a lid 14 formed with a hand hold 20. The lid 14, as shown in FIG. 1 is held in its open position using two lugs 16, located at the read portion of the ultrasonic cleaner, as illustrated in FIG. 1. As is explained in further detail below, the top portion 13 is preferably configured with four lugs 16 (see FIG. 2A) to allow lid 14 to be moved and positioned in place under two lateral directions (illustrated as “A” and “B” in FIG. 1)

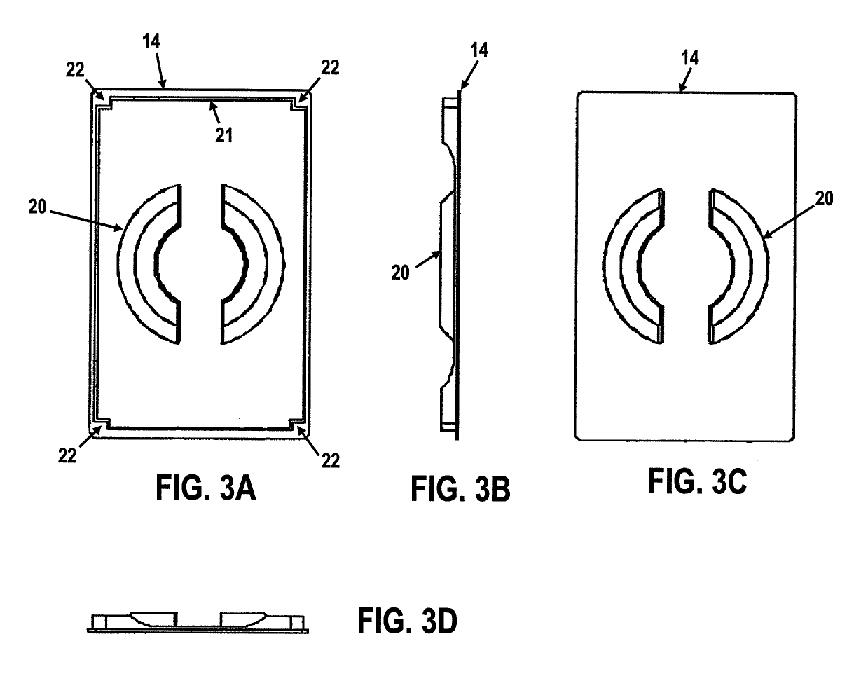

FIGS. 2A-D illustrate a top portion 13 of ultrasonic cleaner apparatus 10, where lugs 16 are preferably located at each of the four corners of the apparatus 10. With this arrangement, the lid 14 (see FIGS. 3A-D) can be opened and held in place by the lugs 16 in any of four directions, and is not limited in the direction of opening as the lid would be if hinges were used. The lugs 16 are spaced away from an edge 15 that circumscribes the interior 18 of the ultrasonic cleaner. An edge of the lid 14 is placed into the space between the lugs 16 and the edge 15. The height of the lug 16 is such that the lid is prevented from sliding out of the space.

FIGS. 3A-D illustrate various views of lid 14 for ultrasonic cleaner apparatus 10. FIG. 3A shows a top view of a lid 14 having a hand hold 20 according to another exemplary embodiment. As shown in FIGS. 3A, the lid 14 also includes insets 22 which correspond to the lugs 16, such that a rim 21 of the lid 14 does not impede the movement of the lid from a closed position to the open position such as that shown in FIG. 1.

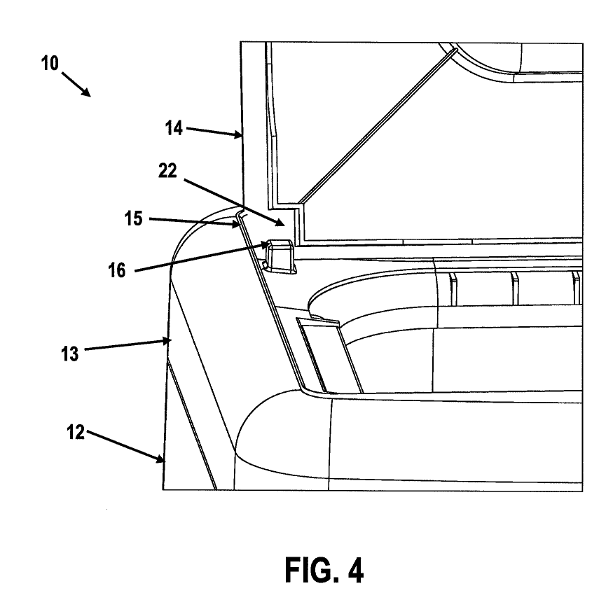

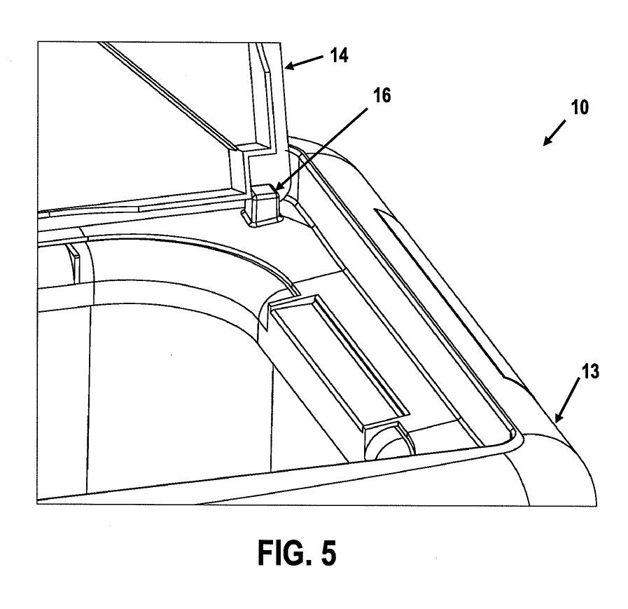

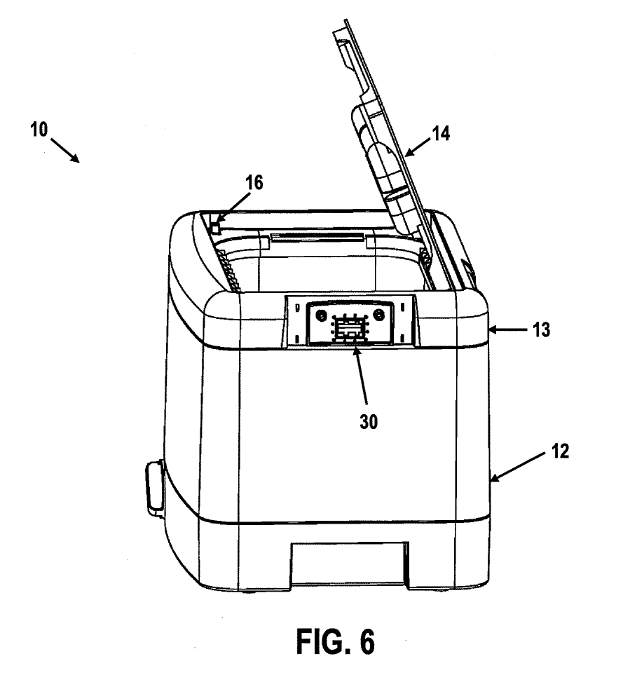

FIG. 4 further illustrates how the insets 22 are designed to go around the lug 16 and allow for the lid 14 to be held in place between the lug 16 and the edge 15 of the ultrasonic cleaner apparatus 10. FIG. 5 shows another view of the positioning of the lid 14 behind the lug 16.

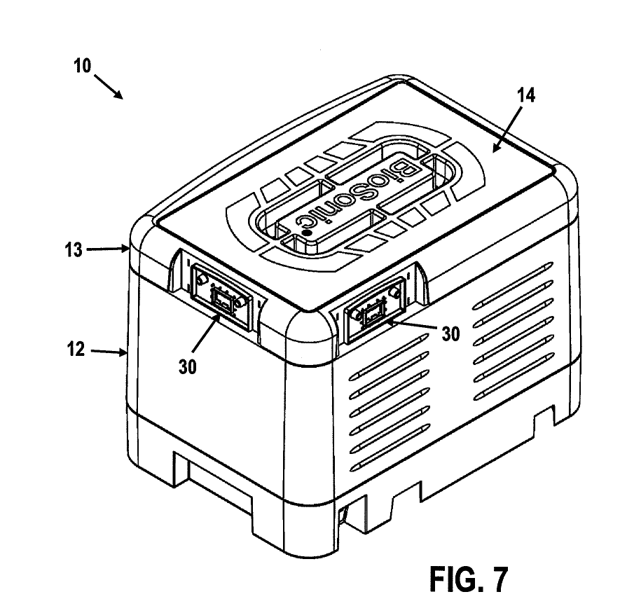

FIG. 6 shows a side view of ultrasonic cleaner 30, where the lugs 16, positioned at all four corners of the ultrasonic cleaner apparatus 10 (see FIG. 2A), allows for the lid 14 to be opened to the side instead of just to the back of the ultrasonic cleaner (directions “A” and “B”—see FIG. 1). Thus, by using the lugs 16 as shown above, the lid 14 can be supported and held open as shown in FIG. 1 and not require either hinges that limit the directions the lid 14 can be opened and which support the lid when ultrasonic cleaner is closed as shown in FIG. 7.

FIG. 7 illustrates another exemplary embodiment, where display connectors 30 are positioned at different sides of top portion 13 to accommodate a display depending on the lateral opening/closing position (“A” or “B”) of lid 14. In the '654 application, discussed above, a display unit is discussed for use with the ultrasonic cleaner. However, as described in the '654 application the ultrasonic cleaner had only a single position in which the display could be secured to the ultrasonic cleaner. As described above, the fixing of the display at a single location led to difficulties by some in incorporating the ultrasonic cleaner in the workspaces of the user as it limited the orientations the ultrasonic cleaner could have to the rest of the space.

According to the embodiment shown in FIG. 7 a display, such as that described in the '654 application, is provided with two separate locations 30 at which the display could be mounted (see also FIGS. 2A-D). This enables any number of configurations of the device and renders it more accessible to the user. When one of the locations 30 is chosen for mounting the display, a cover, can be used to prevent the ingress of the sterilizing fluid or other contaminants into the other location 30. While described herein as having two locations, more locations could also be provided thus increasing the flexibility of the orientation of the ultrasonic cleaner.

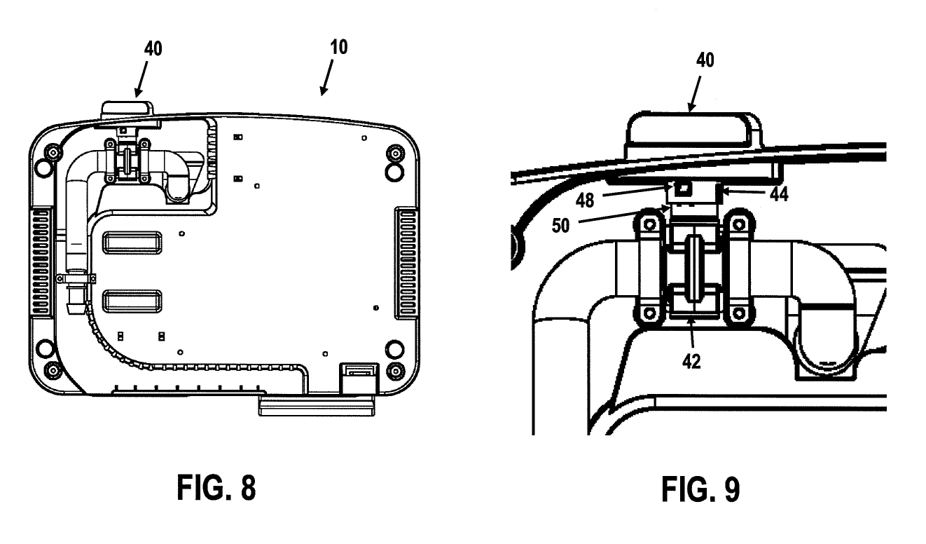

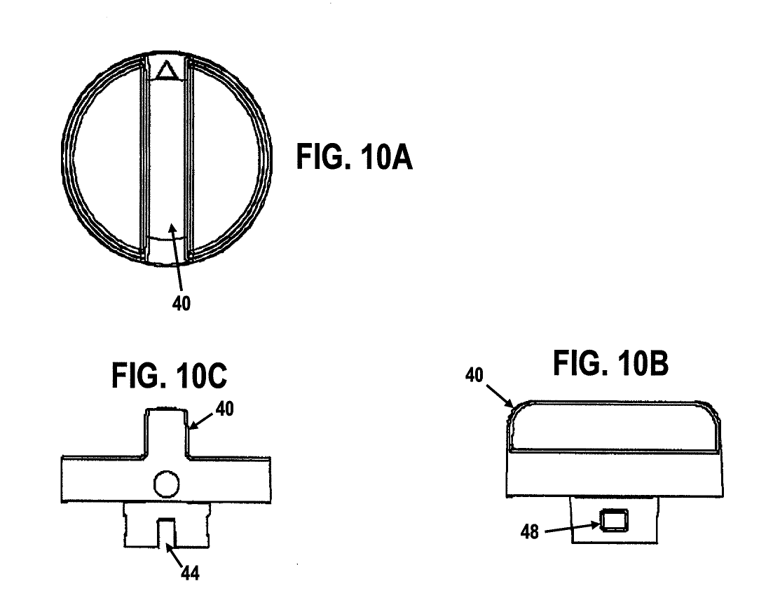

Another exemplary embodiment is shown in FIGS. 8 and 9, where FIG. 8 illustrates a drain assembly incorporated in ultrasonic cleaner 10. FIG. 9 shows a blown-up view of the FIG. 8 assembly and shows a close up view of a drain valve 42. Drain valve 42 is operated by a drain knob 40 (see FIGS. 10A-10C for further details) located on an exterior surface of the ultrasonic cleaner 10. The drain knob 40 includes openings 44 and 48. The opening 44 is for alignment of the drain knob 40 to a coupler 50 which connects to the valve 42. The opening 48 is for securing the drain knob 40 to the coupling and therewith the valve 42.

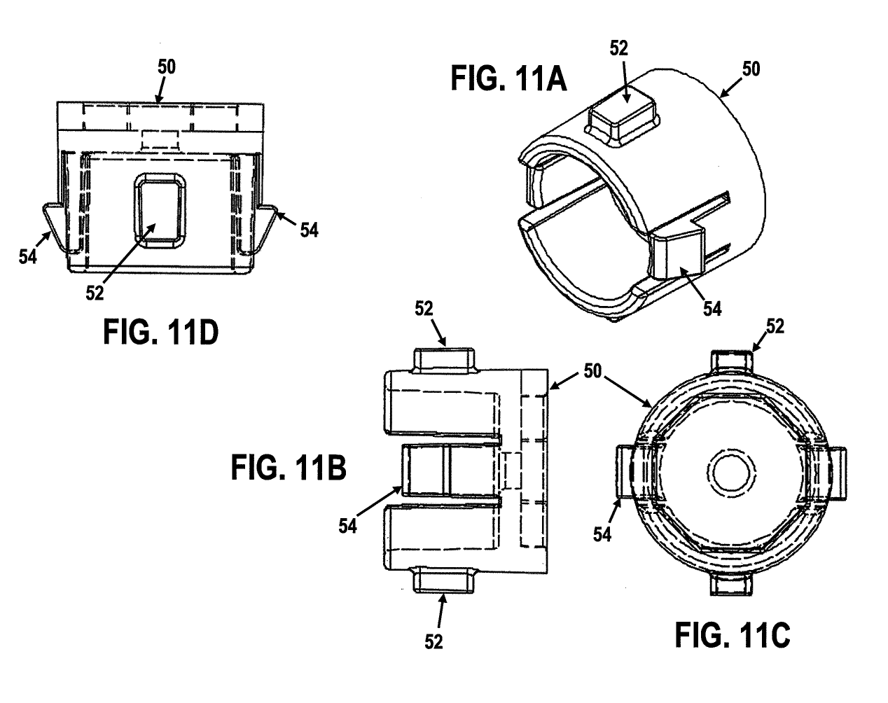

Coupling 50 is illustrated in FIGS. 11A-11D and includes two types of projections 52 and 54 illustrated in the exemplary embodiment. The first type of projection is a straight projection 52 which gests inserted into the openings 44. The second type of projection are the ramped projections 54. The ramped projections 54 can deflect when force is applied to one side. In practice the drain knob 40 is slid onto the coupling 50 such that the openings 44 and the projections 52 align. Once this is established, the drain knob is forced further onto the coupling until the ramp projection is forced through the openings 48. Once the ramp projection 54 is completely inserted into the opening 48, a flat formed on the back side of the ramp projection 54 prevents the removal of the drain knob 40 from the coupling 50. However, if desired the drain knob can be removed by simply deflecting the ramped projections 54 into the openings and pulling the drain knob 40 away from the coupling 50. Once secured to the coupling 50 turning of the drain knob results in opening or closing of the drain valve as desired.

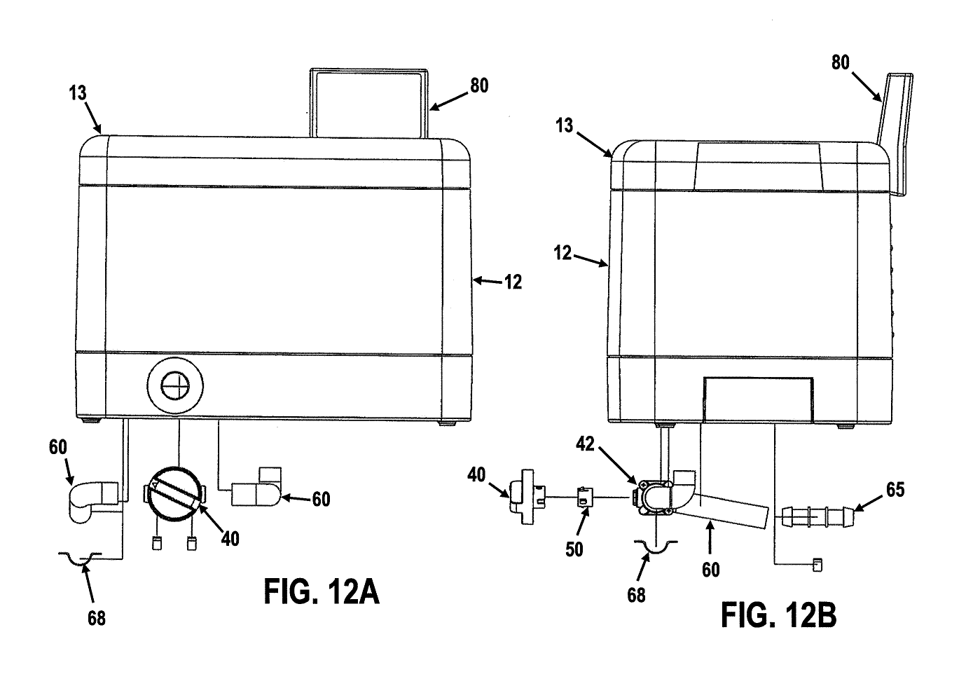

FIGS. 12A-12B illustrate different views of the drain assembly, where drain knob 40 is connected to coupling 50, which connects further to drain valve 42. Drain valve 42 includes appropriate piping 60 to facilitate the flow of fluids being drained from the ultrasonic cleaner. The flow from piping 60 may be directed to other piping (not shown) using pipe coupler 65. Drain valve 42 is preferably fixed to the body 12 using clamps 68, or any other suitable mechanism known in the art. FIGS. 12A-12B further show a display 80 attached in one of the plurality of positions via connectors 30, discussed above.

Thus by the foregoing descriptions the present invention solves many of the shortcomings of the prior art ultrasonic cleaners and their components.

The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples, therefore, do not limit the invention to the specific embodiments described, and the invention includes modifications to these embodiments that do not depart from the spirit and scope of the invention.

Although the invention has been described with reference to particular arrangements and embodiments of services, systems, processors, devices, features and the like, these are not intended to exhaust all possible arrangements or embodiments, and indeed many other modifications and variations will be ascertainable to those of skill in the art. Also, while specific communication protocols are mentioned in this document, one skilled in the art would appreciate that other protocols may be used or substituted. This application covers any adaptations or variations of the present invention. Therefore, the present invention is limited only by the claims and all available equivalents.

What is claimed is:

1. An opening mechanism for a cleaning apparatus, comprising:
a plurality of lugs formed on an top surface of the apparatus;
a lid enclosing the apparatus and resting on the lugs when the lid is in a closed position; and
a rim formed exterior to the lugs, wherein the lid is secured in an open position between two or more of the plurality of lugs and the rim.

2. The opening mechanism according to claim 1, wherein the cleaning apparatus comprises an interior for holding a cleaning solution.

3. The opening mechanism according to claim 1, wherein the top surface comprises four corners, and wherein the lugs are located on each of the four corners.

4. The opening mechanism according to claim 3, wherein the lugs are spaced away from the rim.

5. The opening mechanism of claim 4, wherein the lugs are configured to be high enough to prevent the lid from sliding out of a space between the lugs and the rim.

6. The opening mechanism of claim 3, wherein the open position for the lid, relative to the cleaning apparatus, is in a direction that is one of a first side position, a second side position, a front position, and a back position.

7. An apparatus for cleaning, comprising:
an enclosure having an interior space, configured to receive a cleaning solution;
a user interface for selecting cleaning functions for the apparatus;
two or more locations for mounting the user interface to the apparatus; and
a cover to prevent the ingress of foreign material into the other of the locations to which the user interface is not mounted.

8. The apparatus according to claim 7, wherein the foreign material comprises one of fluids and contaminants.

9. The apparatus according to claim 7, wherein the cleaning functions comprise actions to be taken by the apparatus during a cleaning cycle.

10. The apparatus according to claim 7, wherein the cleaning functions comprise a timing of one or more cleaning cycles of the apparatus.

11. A drain assembly comprising:
a drain valve;
a coupling operatively engaging the drain valve, said coupling including at least one alignment projection and at least one ramped projection; and
a drain knob, said drain knob engaging the coupling and including at least one straight opening for receiving the alignment projection and at least one securing opening to receive the ramped projection and prevent the removal of the drain knob from the coupling once inserted therein.

12. The drain assembly according to claim 11, wherein the ramped projection is configured to deflect when force is applied to one side.

13. The drain assembly according to claim 12, wherein the ramped projection and securing opening form a flat to prevent the removal of the drain knob.

14. The drain assembly according to claim 12, wherein the drain assembly is operatively coupled to a cleaning apparatus.
